(19) United States
(12) Patent Application Publication
(10) Pub. No.: US 2004/0095312 A1
(43) Pub. Date: May 20, 2004

(54) Infrared remote-control laser pointer

(76) Inventor: Sean Chen, Taipei (TW)

Correspondence Address: RABIN & BERDO, P.C., Suite 500, 1101 14th Street, N.W., Washington, DC, 20005, US

(21) Appl. No.: 10/299,832

(22) Filed: Nov. 20, 2002

(51) Int. Cl. G09G 5/00

(52) U.S. Cl. 345/156

(57) ABSTRACT

An infrared remote-control laser pointer capable of emitting a pointing light spot is provided with an infrared transmitter to work with a receiver electrically connected to a computer. By selectively pushing one of two push-button switches externally provided on the laser pointer, an encoded infrared signal is emitted and transmitted from the pointer to the receiver. When the transmitted infrared signal is decoded and determined as a correct signal, a signal emulating a mouse-controlled page up or down instruction is input to the computer via a USB interface to perform the page up or down function on the computer. Thus, a user may independently, quickly, and correctly control the computer to page up or down while using the laser pointer to report in a briefing or teach in a classroom.

### FIELD OF THE INVENTION

The present invention relates to an infrared remote-control laser pointer, and more particularly to a novel laser pointer capable of emitting and transmitting an infrared signal to control a computer to page up and down.

### BACKGROUND OF THE INVENTION

A laser pointer, such as a laser pen, is a tool frequently used in teaching and commercial briefing to project a light spot on a plane or a screen, in order to indicate the contents being taught or reported.

A conventional laser pointer is usually provided with a push button for electrically connecting an internal control circuit of the pointer, so that a laser module is caused to emit a laser beam, which forms a picture or a light spot or other different patterns when being projected on a plane. With the highly developed computer technologies, a computer screen has been widely utilized in teaching and briefing to display the teaching and reporting materials to help the audience to understand what is taught or reported. Since the laser light is very suitable for forming a light spot on the computer screen, the laser pointer has become an important tool for using with a computer in teaching and briefing. A problem with the conventional laser pointer when the same is used with a computer in teaching and briefing is the user has to frequently operate a keyboard or a mouse to page the computer screen up and down.

In the case the teaching or reporting materials are produced with, for example, the software of Power Point, they are usually shown on a big screen in the teaching or briefing, and a teacher or a reporter would usually stand in front of the big screen. In this case, an assistant is usually required to operate the computer to page up and down the screen. There are times what displayed on the screen is not what wanted by the teacher or the reporter, and a lot of time is wasted in correcting the wrong pictures.

### SUMMARY OF THE INVENTION

It is therefore a primary object of the present invention to provide an infrared remote-control laser pointer, with which the user alone is enough to quickly and correctly control a computer to page up and down in a computer-aid teaching or briefing.

To achieve the above object, the laser pointer of the present invention is provided with an infrared signal emission circuit to emit an infrared signal capable of emulating a mouse-controlled page instruction, and two push-button switches for separately control the emission of a Page Up and a Page Down infrared signal. In the case a computer having a corresponding infrared receiver is used with the laser pointer, the computer screen can be directly controlled with the laser pointer to page up and down.

Another object of the present invention is to provide an infrared remote-control laser pointer having an external receiver to work with it to transmit an infrared signal to a computer connected to the receiver, in the case the computer does not include a corresponding infrared receiver. To achieve this object, the receiver is plugged to the computer via a universal serial bus (USB) connector to receive an encoded infrared signal transmitted from the laser pointer. When the received infrared signal is decoded and determined as a correct signal by the receiver, a signal emulating the mouse-controlled page instruction is generated and input to the computer via the USB interface to page the computer screen up and down.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1A is a perspective view of an infrared remote-control laser pointer according to an embodiment of the present invention;

FIG. 1B is an exploded perspective view of FIG. 1A;

FIG. 1C shows an example of using the infrared remote-control laser pointer of the present invention with an external receiver;

FIG. 2 is a laser emission circuit diagram for the infrared remote-control laser pointer of the present invention;

FIG. 3 is an infrared signal emission circuit diagram for the infrared remote-control laser pointer of the present invention;

FIG. 4 is a circuit diagram for a corresponding receiver working with the infrared remote-control laser pointer of the present invention; and

FIG. 5 is a circuit diagram for another embodiment of the infrared remote-control laser pointer of the present invention, wherein the laser emission and the infrared signal emission circuits are combined.

### DETAILED DESCRIPTION OF THE PREFERRED EMBODIMENTS

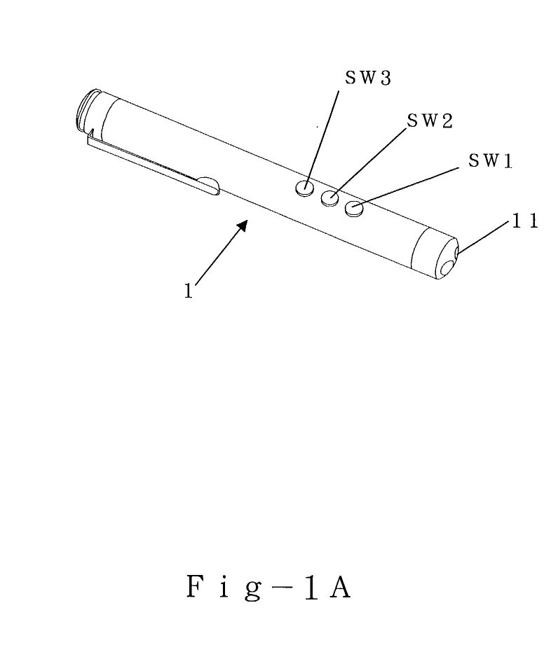

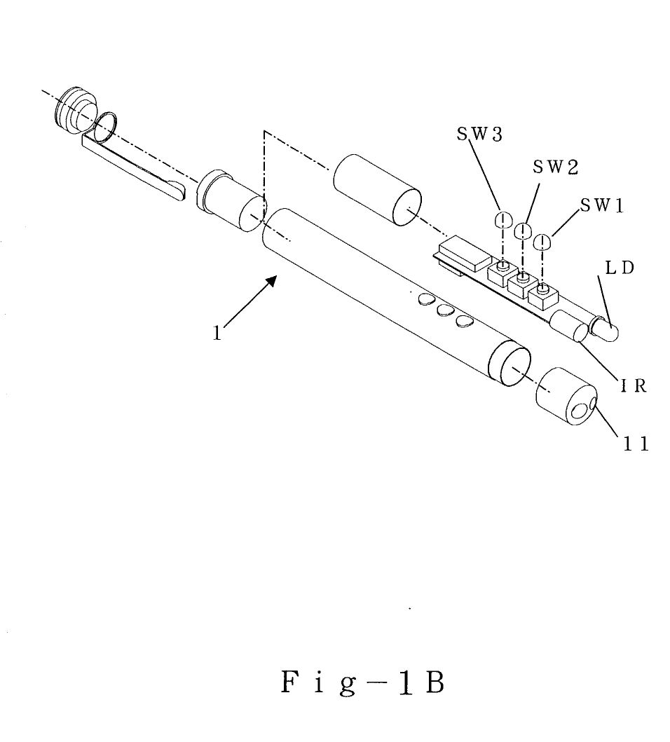

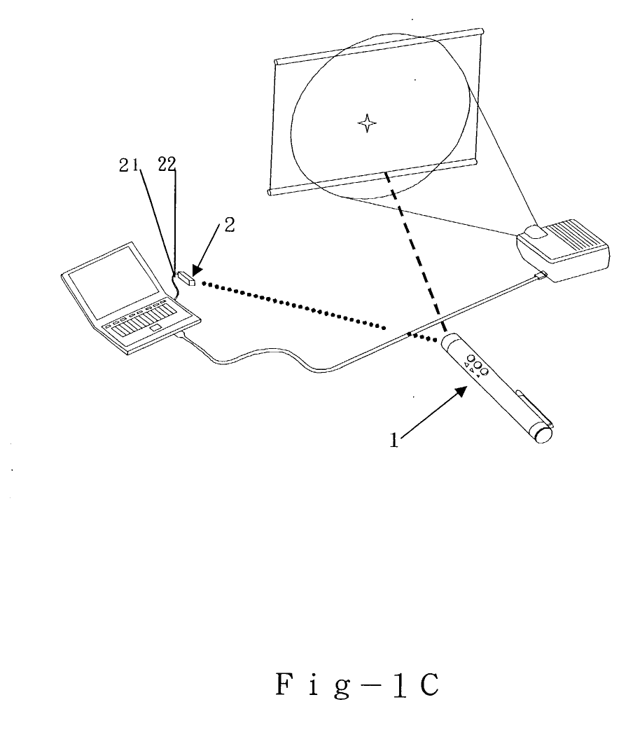

Please refer to FIGS. 1A and 1B that are assembled and exploded perspective views, respectively, of a laser pointer 1 according to an embodiment of the present invention. As shown, the laser pointer 1 is provided at predetermined positions with three push-button switches SW1, SW2, and SW3, and internally provided with at least one battery and a circuit board.

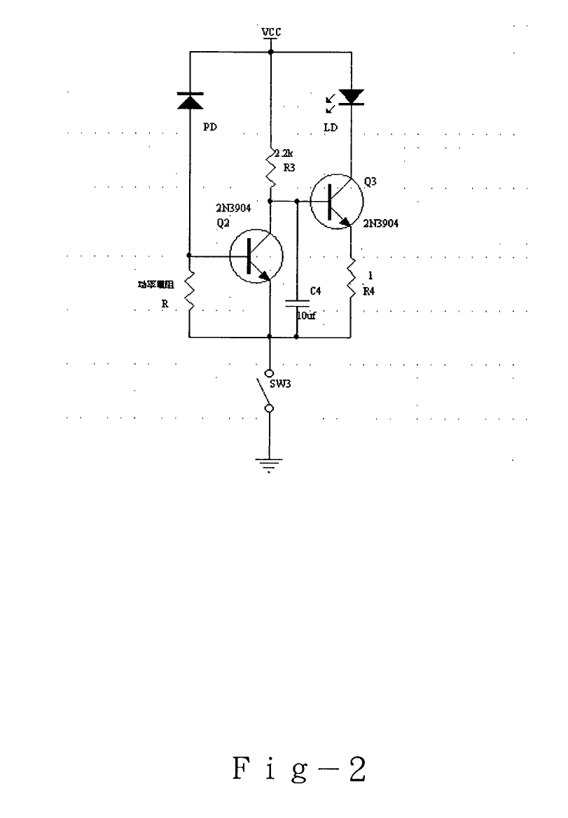

The third switch SW3 is a laser beam control switch. When the third switch SW3 is pushed, a laser beam is emitted from an opening 11 provided at a front end of the pointer 1 to form a light spot or a certain design on a plane. FIG. 2 is a laser emission circuit diagram for the laser pointer 1. When the third switch SW3 is pushed, the laser emission circuit is electrically connected, and two transistors Q2, Q3 thereof oscillate to cause a laser diode LD to emit the laser beam.

Please refer back to FIG. 1A. The first switch SW1 on the laser pointer 1 is a control switch for shifting a computer screen to a previous page, that is, a control switch for providing a Page Up function; and the second switch SW2 is a control switch for shifting a computer screen to a following page, that is, a control switch for providing a Page Down function.

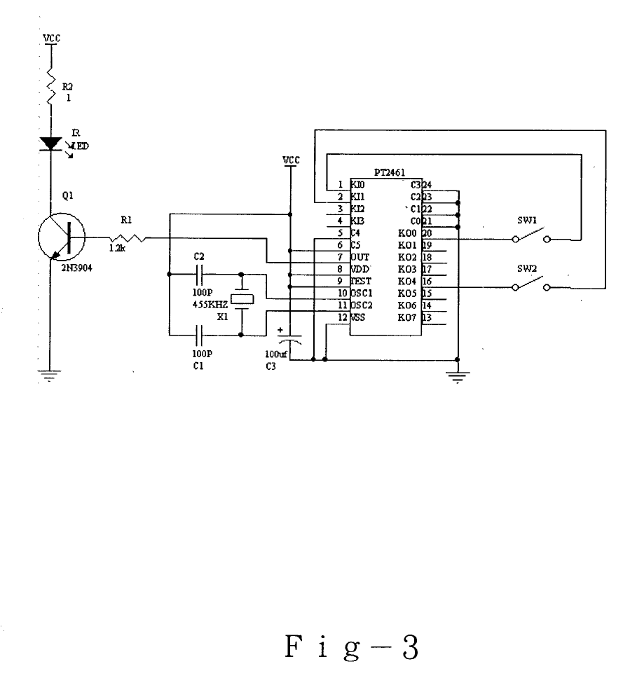

FIG. 3 is an infrared signal emission circuit diagram for the laser pointer 1 of the present invention. As shown, the infrared signal emission circuit supplies a voltage Vc to a microprocessor IC, which is a processor capable of emitting an encoded infrared signal. When the first switch SW1 is pushed, a transistor Q1 is actuated to cause an infrared-emitting diode IR to emit an encoded infrared signal, which is transmitted to and received by a receiver 2 connected to a computer via a universal serial bus (USB) connector JP1 to page a display on the screen of the computer to a previous picture. Similarly, when the second switch SW2 is pushed, the transistor Q1 is actuated to cause the infrared-emitting diode IR to emit another encoded infrared signal, which is transmitted to and received by the receiver 2 connected the computer via the USB connector JP1 to page the display on the screen of the computer to a next picture.

The microprocessor IC shown in FIG. 3 is a remote control transmitter that is specially designed with the Complementary Metal-Oxide Semiconductor (CMOS) technique to emit infrared ray and has 24 pins. A signal is output via one of the pins from KO0 to KO7, and is input via one of the pins from KI0 to KI3. As shown in FIG. 3, when the first switch SW1 is pushed, a signal is output at the pin KO0 and input at the pin KI0. At this point, the microprocessor IC will obtain an 8-bit code, which and signals at pins from C0 to C5, plus C6 to C12 that are originally provided in the microprocessor IC, together form a 42-bit code. The 42-bit code is output to an infrared module IR and is transmitted therefrom. And, when the second switch SW2 is pushed, the signal is output at the pin KO4 and input at the pin KI1. At this point, the microprocessor IC will obtain another 8-bit code, which and signals at pins from C0 to C5, plus C6 to C12 that are originally provided in the microprocessor IC, together form another 42-bit code. This 42-bit code is output to the infrared module IR and is transmitted therefrom.

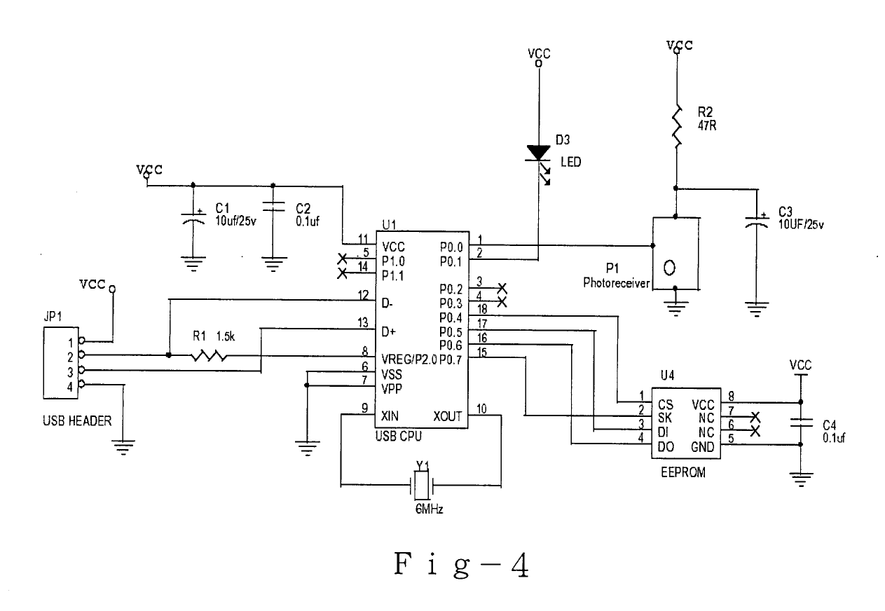

Please refer to FIG. 4 that is a circuit diagram for a receiver 2 further included in the present invention. The receiver 2 is a photo-receiver P1 for receiving an infrared signal transmitted from the laser pointer 1. The received infrared signal is input to a central processor U1, at where the signal is decoded to emulate a mouse-controlled Page Up signal and be input to a computer for controlling the movement of Page Up. When a receiving module in the receiver P1 shown in FIG. 4 receives an infrared signal transmitted from the infrared module IR shown in FIG. 3, the received signal is compared to determine whether it matches with a preset code or not. When the received signal is determined as matching with the code obtained by pushing the first switch SW1, a signal emulating the function of Page Up is sent out via an interface of the USB connector JP1 to the computer to page the screen to a previous picture. Similarly, when the received signal is determined as matching with the code obtained by pushing the second switch SW2, a signal emulating the function of Page Down is sent out via the interface of the USB connector JP1 to the computer to page the screen to a next picture.

Moreover, the receiver 2 may be internally provided with a light emitting diode (LED) for indicating a power on/off status or a signal receiving condition of the pointer 1.

In FIG. 1C, there is shown an example of using the pointer land the receiver 2 to control a computer in a briefing. The USB connector JP1 is connected to the receiver 2 via a conducting wire 21 or a flexible tube 22 and plugged to a USB socket on the computer. This design allows the receiver 2 to be conveniently connected to the computer, and the flexible tube 22 is particularly useful in easy adjustment of a signal-receiving angle of the receiver 2. Problems such as poor signal reception are therefore avoided.

It is understood the laser pointer 1 of the present invention is not necessarily limited to a configuration of pen as shown in FIG. 1A. Moreover, the laser pointer 1 is not necessarily powered with a battery mounted in the pointer, which may be otherwise powered by connecting it to an external power supply. These simple and functionally equivalent changes should be included in the scope of the present invention.

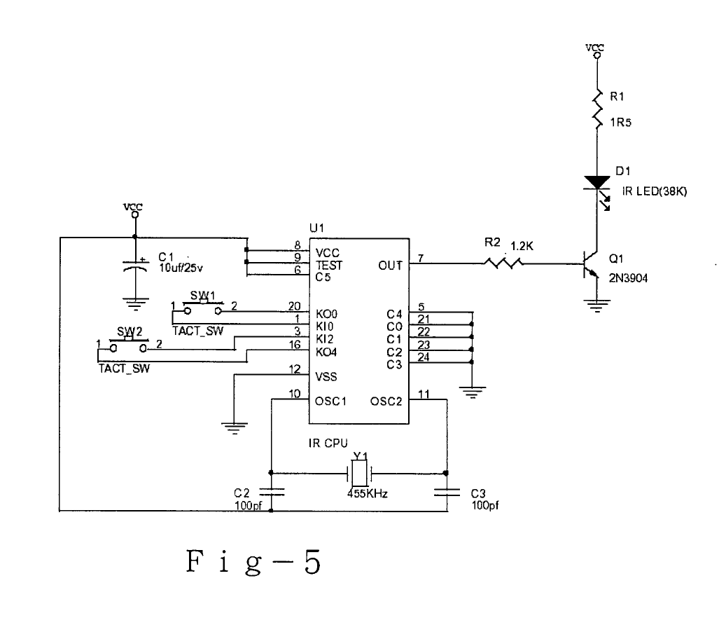

FIG. 5 is a circuit diagram for another embodiment of the present invention, in which the laser emission circuit and the infrared signal emission circuit in the first embodiment are combined.

With the above-described arrangements, the laser pointer of the present invention has the function of controlling a computer to page up and down. A user may independently control the computer with the pointer to correctly and quickly page up and down the screen while reporting in a briefing or teaching in a classroom. The present invention is therefore a novel and improved product.

What is claimed is:

1. An infrared remote-control laser pointer, comprising:
a laser emission circuit consisting of at least one laser diode, which is controlled via a third push-button switch externally provided on said pointer to emit a laser beam, and said emitted laser beam being transmitted via an opening provided at a predetermined position on said pointer; and
a laser emission circuit consisting of at least one an infrared signal emission circuit consisting of an infrared emitting diode, and a microprocessor electrically connected to a first and a second push-button switch; said infrared emitting diode being caused by said microprocessor to emit a signal emulating a mouse-controlled Page Up instruction when said first push-button switch is pushed, in order to remotely control a computer to page to a previous picture; and said infrared emitting diode being caused by said microprocessor to emit a signal emulating a mouse-controlled Page Down instruction when said second push-button switch is pushed, in order to remotely control the computer to page to a next picture.

2. The laser pointer as claimed in claim 1, wherein said signals emitted by said infrared signal emission circuit are encoded infrared signals.

3. The laser pointer as claimed in claim 2, further comprising a separate receiver being electrically connected to said computer via a connector; said receiver including a receiving circuit for receiving said encoded infrared signals transmitted from said infrared signal emission circuit, and being capable of decoding said received infrared signal in order to send said emulated page signal to said computer via said connector when said decoded signal, is determined as a correct signal.

4. The laser pointer as claimed in claim 3, wherein said connector for connecting said receiver to said computer is a universal serial bus (USB) connector.

5. The laser pointer as claimed in claim 3, wherein said receiver includes a light emitting diode for indicating an operating status of said receiver, such as a power supply condition or a signal reception condition thereof.

6. The laser pointer as claimed in claim 3, wherein said receiver is plugged to a USB socket on said computer via a conducting wire or a flexible tube.
